(19) United States
(12) Patent Application Publication
(10) Pub. No.: US 2012/0262143 A1
(43) Pub. Date: Oct. 18, 2012

(54) SEMICONDUCTOR INTEGRATED CIRCUIT FOR CONTROLLING REGULATOR CIRCUIT AND SIGNAL PROCESSOR WHICH OPERATES BASED ON OUTPUT VOLTAGE THEREOF

(76) Inventor: Hiroo YAMAMOTO, Kyoto (JP)

(21) Appl. No.: 13/415,522

(22) Filed: Mar. 8, 2012

Related U.S. Application Data
(63) Continuation-in-part of application No. PCT/JP2010/003757, filed on Jun. 4, 2010.

(30) Foreign Application Priority Data
Sep. 8, 2009 (JP) 2009-207125

(51) Int. Cl. G05F 3/02

(52) U.S. Cl. 323/304

(57) ABSTRACT

A control circuit receives a change request for an operating mode of a signal processor which operates based on an output voltage of a regulator circuit, changes the output voltage of the regulator circuit, and then changes the operating mode of the signal processor based on the change request.

### CROSS-REFERENCE TO RELATED APPLICATION

This is a continuation-in-part of PCT International Application PCT/JP2010/003757 filed on Jun. 4, 2010, which claims priority to Japanese Patent Application No. 2009-207125 filed on Sep. 8, 2009. The disclosures of these applications including the specifications, the drawings, and the claims are hereby incorporated by reference in its entirety.

### BACKGROUND

The present disclosure relates to semiconductor integrated circuits (ICs), and more particularly to semiconductor ICs each for controlling a regulator circuit and a signal processor which operates based on an output voltage of the regulator circuit.

Large-scale logic circuits etc. are adapted to improve operational performance and to reduce power consumption by changing the frequency of a clock signal, or by switching between permitting and stopping the supply of the clock signal as needed. In particular, hand-held electronic devices which require low power consumption ensure high operational performance by each increasing the frequency of the clock signal in a normal operating mode, and save power consumption by reducing the frequency of the clock signal in an operating mode such as a stand-by mode.

In general, a signal processor, such as a logic circuit, is supplied with a constant voltage from a regulator circuit, and operates based on the constant voltage. The output of the regulator circuit varies during a short transitory period after a change in the operating mode of the signal processor. For example, when a signal processor switches to a high load mode, the output of the regulator circuit exhibits an undershoot, and conversely, when a signal processor switches to a low load mode, the output of the regulator circuit exhibits an overshoot.

When the operating mode of the signal processor is changed, and if, for example, the frequency of the clock signal is rapidly changed, then the amount of current consumption of the signal processor—that is, the amount of load—rapidly changes, thereby causing the output of the regulator circuit to widely change. If the output of the regulator circuit changes to a level above or below an acceptable range of the operating voltage of the signal processor, then the signal processor may malfunction or fail.

Thus, when the signal processor operates in a high load mode, the regulator circuit is changed to a high-performance control mode, while when the signal processor operates in a low load mode, the regulator circuit is changed to a low-performance control mode (see, e.g., Japanese Patent Publication No. 2002-051459). In another case, when the operating mode of the signal processor is changed, the frequency of the clock signal is not changed rapidly, but is changed in discrete steps (see, e.g., Japanese Patent Publication No. 2005-122374).

The present inventor has recognized the problems described below. According to the first conventional technology described above, an operation of the signal processor in a high load mode causes the regulator circuit to be controlled so as to respond more quickly, thereby increasing the power consumption. Meanwhile, a reduction in the response speed of the regulator circuit to reduce the power consumption requires extending the acceptable range of voltage drop of the signal processor, which leads to a decrease in the performance of the signal processor. According to the second conventional technology described above, for example, a stepwise change in the frequency of the clock signal from zero to near 1 GHz requires a long time. Moreover, a need for a large-scale clock frequency changing circuit for changing the clock frequency in multiple steps causes a cost increase.

### SUMMARY

The present invention is advantageous when the operating mode of a signal processor needs to be stably changed with less power consumption, and is also advantageous when the operating mode of a signal processor needs to be changed more quickly.

A semiconductor integrated circuit (IC) according to an aspect of the present invention is a semiconductor IC for controlling a regulator circuit and a signal processor which operates based on an output voltage of the regulator circuit, including a control circuit configured to receive a change request for an operating mode of the signal processor, to change the output voltage of the regulator circuit, and then to change the operating mode of the signal processor based on the change request. More specifically, if the change request specifies an increase in an amount of load of the signal processor, the control circuit increases the output voltage of the regulator circuit, and if the change request specifies a reduction in the amount of load of the signal processor, the control circuit reduces the output voltage of the regulator circuit.

According to this control, the operating mode of the signal processor can be changed after the output voltage of the regulator circuit is changed. Thus, the response speed of the regulator circuit does not need to be increased when the operating mode of the signal processor is changed, thereby allowing the operating mode of the signal processor to be stably changed with less power consumption.

The control circuit may change the operating mode of the signal processor in discrete steps. For example, the operating mode of the signal processor first transitions to an intermediate stage, and then, after the output voltage of the regulator circuit has stabilized, the control circuit changes the operating mode of the signal processor to a next stage. In this case, the semiconductor IC may include a voltage monitoring circuit configured to detect that the output voltage of the regulator circuit has stabilized. Alternatively, the control circuit includes a timer circuit configured to determine that a predetermined time period which is less than or equal to one second has elapsed since the operating mode of the signal processor transitioned to an intermediate stage, and when the timer circuit times out, the control circuit changes the operating mode of the signal processor to a next stage.

According to this control, even if a change request for the operating mode is provided, and the change request results in a rapid change in the amount of load of the signal processor, the operating mode of the signal processor can be stably changed.

Alternatively, the operating mode of the signal processor first transitions to an intermediate stage, and then, after a predetermined time period has elapsed since the output voltage of the regulator circuit has become a normal voltage, the control circuit changes the operating mode of the signal processor to a next stage. In this case, the semiconductor IC may include a voltage monitoring circuit configured to detect that the output voltage of the regulator circuit has become the noiinal voltage.

According to this control, even if a change request for the operating mode is provided, and the change request results in a rapid change in the amount of load of the signal processor, the operating mode of the signal processor can be changed stably and quickly.

The semiconductor IC may include a memory, such as a non-volatile memory, configured to store correction information for adjusting, to a predetermined value, a time period from when the output voltage of the regulator circuit is changed until the operating mode of the signal processor is changed. In this case, the control circuit changes the operating mode of the signal processor after the time adjusted based on the correction information stored in the memory has elapsed since the output voltage of the regulator circuit was changed.

According to this control, even if semiconductor ICs have manufacturing variation, or even if the operating environment changes, the time period from when the output voltage of the regulator circuit is changed until the operating mode of the signal processor is changed can be made substantially the same.

### BRIEF DESCRIPTION OF THE DRAWINGS

FIG. 1 is a configuration diagram of an electronic device according to the first embodiment.

FIG. 2 is a configuration diagram illustrating an example of a change in the operating mode of the signal processor.

FIG. 3 is a configuration diagram of an example of the control circuit.

FIG. 4 is a configuration diagram of another example of the control circuit.

FIG. 5 is a waveform diagram illustrating the operation of the electronic device of FIG. 1.

FIG. 6 is a configuration diagram of an electronic device according to the second embodiment.

FIG. 7 is a waveform diagram illustrating an operation when the operating mode of the signal processor is changed in discrete steps.

FIG. 8 is a waveform diagram illustrating another operation when the operating mode of the signal processor is changed in discrete steps.

FIG. 9 is a configuration diagram of an electronic device according to the third embodiment.

### DETAILED DESCRIPTION

### First Embodiment

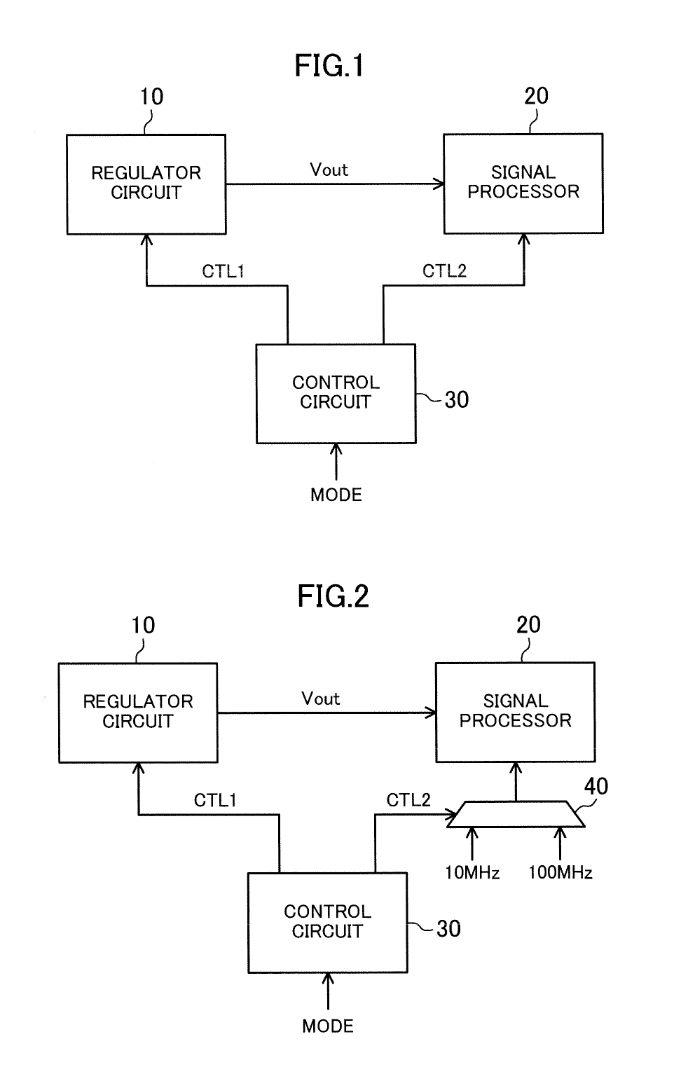

FIG. 1 illustrates a configuration of an electronic device according to the first embodiment. The regulator circuit 10 regulates the power supplied from a power supply circuit (not shown) so as to have a constant voltage, and outputs the constant voltage. The signal processor 20 is supplied with the output voltage Vout of the regulator circuit 10, and operates based on the output voltage Vout. The signal processor 20 is adapted to operate in various operating modes. The control circuit 30 receives a change request MODE for an operating mode of the signal processor 20, outputs a control signal CTL1, thereby changes the output voltage Vout of the regulator circuit 10, and then outputs a control signal CTL2, thereby changes the operating mode of the signal processor 20. More specifically, if the change request MODE specifies an increase in the amount of load of the signal processor 20, the control circuit 30 increases the output voltage Vout of the regulator circuit 10, and if the change request MODE specifies a reduction in the amount of load of the signal processor 20, the control circuit 30 reduces the output voltage Vout of the regulator circuit 10. The change request MODE is output from a register, a central processing unit (CPU), etc., which are not shown. The regulator circuit 10, the signal processor 20, and the control circuit 30 may be respectively implemented in separate semiconductor ICs, or the regulator circuit 10 and the control circuit 30 may be implemented in a same semiconductor IC.

As shown in FIG. 2 for example, the operating mode of the signal processor 20 can be changed by changing the frequency of a clock signal supplied to the signal processor 20. The frequency changing circuit 40 supplies, for example, one of clock signals having frequencies of 10 MHz and 100 MHz based on the control signal CTL2 to the signal processor 20. In addition, for example, if the signal processor 20 performs image processing, the operating mode can be changed by changing the number of channels relating to the image processing. Moreover, if the signal processor 20 includes multiple functional cores, the operating mode can be changed by changing the number of functional cores to operate, using a clock gating technique.

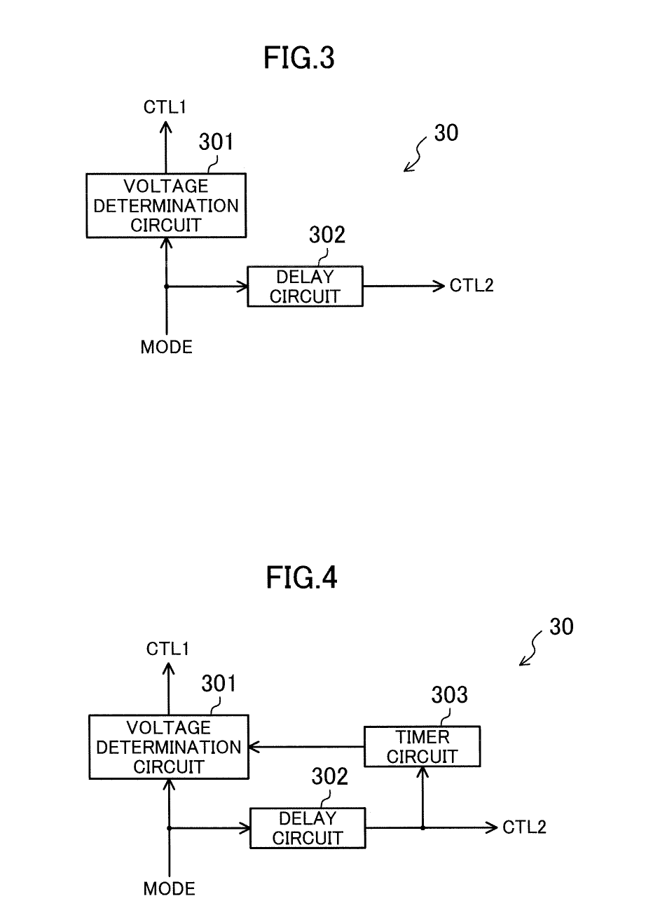

FIG. 3 illustrates a configuration of an example of the control circuit 30. The voltage determination circuit 301 predicts a change in the amount of load of the signal processor 20 based on two types of information, which are the current operating mode of the signal processor 20 and the operating mode indicated by the change request MODE, determines a target voltage of the output voltage Vout of the regulator circuit 10, and outputs the control signal CTL1. For example, assuming that the signal processor 20 has three operating modes: a first operating mode corresponding to a low load, a second operating mode corresponding to a medium load, and a third operating mode corresponding to a high load, if the operating mode is to transition from the first operating mode to the second or the third operating mode, and from the second operating mode to the third operating mode, then the target voltage is set to a higher value. Meanwhile, if the operating mode is to transition from the third operating mode to the first or the second operating mode, and from the second operating mode to the first operating mode, then the target voltage is set to a lower value. The delay circuit 302 delays the change request MODE, and outputs the delayed change request MODE as the control signal CTL2.

The control circuit 30 may set the output voltage Vout of the regulator circuit 10 back to the normal voltage after a predetermined time period has elapsed since the operating mode of the signal processor 20 was changed. FIG. 4 illustrates a configuration of another example of the control circuit 30. The control circuit 30 according to this example further includes a timer circuit 303 in addition to the components shown in FIG. 3. The timer circuit 303 detects that a predetermined time period has elapsed since the control signal CTL2 was changed, that is, since the control circuit 30 changed the operating mode of the signal processor 20. The predetermined time period is set to, for example, less than or equal to one second. When receiving a timeout notification from the timer circuit 303, the voltage determination circuit 301 outputs the control signal CTL1 which sets the output voltage Vout of the regulator circuit 10 back to the normal voltage.

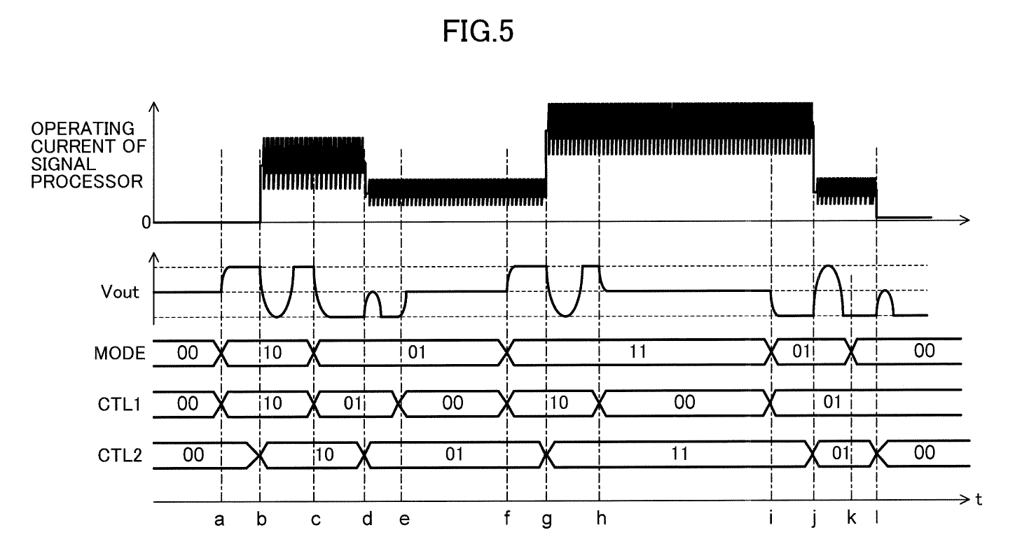

Next, referring to the waveform diagram of FIG. 5, the operation of the electronic device according to this embodiment will be described. For purposes of illustration, it is assumed that the signal processor 20 has a first through a fourth operating modes in ascending order of corresponding amounts of loads, and that a larger two-bit value of the change request MODE leads to a larger amount of load of the signal processor 20.

Before time “a,” the signal processor 20 is in a stand-by state (first operating mode), and thus the operating current of the signal processor 20 is nearly zero. In this condition, the change request MODE and the control signals CTL1 and C112 each have an initial value “00,” and the output voltage Vout of the regulator circuit 10 is the normal voltage.

At the time “a,” when the change request MODE transitions to a value “10” representing the third operating mode, the control signal C1L1 transitions to a value “10,” thereby causing the output voltage Vout to be set to a higher voltage than the normal voltage. The transition of the change request MODE at the time “a” is transmitted with a delay, and thus at time “b,” the control signal CTL2 transitions to the value “10,” thereby causing the signal processor 20 to start operating in the third operating mode. Although an increase in the operating current during a short transitory period after the change in the operating mode causes an undershoot of the output voltage Vout, the output voltage Vout thereafter returns to the higher voltage in about several tens of microseconds, and thus the output voltage Vout stabilizes.

At time “c,” when the change request MODE transitions to a value “01” representing the second operating mode, the control signal CTL1 transitions to a value “01,” thereby causing the output voltage Vout to be set to a lower voltage than the normal voltage. The transition of the change request MODE at the time “c” is transmitted with a delay, and thus at time “d,” the control signal CTL2 transitions to the value “01,” thereby causing the signal processor 20 to start operating in the second operating mode. Although a decrease in the operating current during a short transitory period after the change in the operating mode causes an overshoot of the output voltage Vout, the output voltage Vout thereafter returns to the lower voltage in about several tens of microseconds, and thus the output voltage Vout stabilizes.

If the control circuit 30 includes the timer circuit 303 as in the example of FIG. 4, the control signal CTL1 transitions to the value “00” at time “e,” thereby causing the output voltage Vout to return to the normal voltage.

At time “f,” when the change request MODE transitions to a value “11” representing the fourth operating mode, the control signal CTL1 transitions to the value “10,” thereby causing the output voltage Vout to be set to a higher voltage than the normal voltage. The transition of the change request MODE at the time “f” is transmitted with a delay, and thus at time “g,” the control signal CTL2 transitions to the value “11,” thereby causing the signal processor 20 to start operating in the fourth operating mode. Although an increase in the operating current during a short transitory period after the change in the operating mode causes an undershoot of the output voltage Vout, the output voltage Vout thereafter returns to the higher voltage in about several tens of microseconds, and thus the output voltage Vout stabilizes.

If the control circuit 30 includes the timer circuit 303 as in the example of FIG. 4, the control signal CTL1 transitions to the value “00” at time “h,” thereby causing the output voltage Vout to return to the normal voltage.

At time “i,” when the change request MODE transitions to the value “01” representing the second operating mode, the control signal CTL1 transitions to the value “01,” thereby causing the output voltage Vout to be set to a lower voltage than the normal voltage.

The transition of the change request MODE at the time “i” is transmitted with a delay, and thus at time “j,” the control signal CTL2 transitions to the value “01,” thereby causing the signal processor 20 to start operating in the second operating mode. Although a decrease in the operating current during a short transitory period after the change in the operating mode causes an overshoot of the output voltage Vout, the output voltage Vout thereafter returns to the lower voltage in about several tens of microseconds, and thus the output voltage Vout stabilizes.

At time “k,” even when the change request MODE transitions to the value “00” representing the first operating mode, the control signal CTL1 remains at the value “01,” thereby causing the output voltage Vout to remain the lower voltage. Thus, if the signal processor 20 is to transition to a stand-by state, the control signal C′IL1 may be kept unchanged even if the change request MODE transitions. The transition of the change request MODE at the time “k” is transmitted with a delay, and thus at time “l,” the control signal CTL2 transitions to the value “00,” thereby causing the signal processor 20 to transition to the stand-by state. Although a decrease in the operating current during a short transitory period after the change in the operating mode causes an overshoot of the output voltage Vout, the output voltage Vout thereafter returns to the lower voltage in about several tens of microseconds, and thus the output voltage Vout stabilizes.

Thus, according to this embodiment, the output voltage of the regulator circuit is preliminarily adjusted depending on an increase or a decrease in the amount of load of the signal processor. Accordingly, the operating mode of the signal processor can be changed stably and similarly to when the response speed of the regulator circuit is increased, without an increase in the power consumption which occurs when the response speed is increased.

Note that the regulator circuit 10 may change the output voltage Vout depending on the change in the operating current value of the signal processor 20.

Although the description of this embodiment has described the control signals CTL1 and CTL2 as digital signals, these control signals may be analog signals.

### Second Embodiment

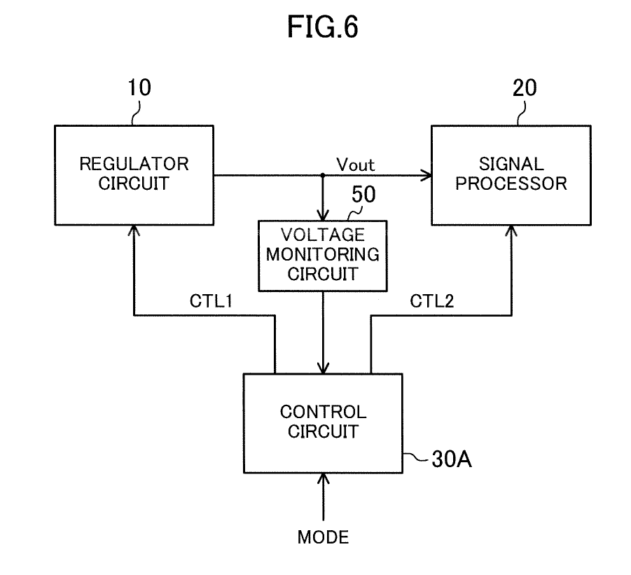

FIG. 6 illustrates a configuration of an electronic device according to the second embodiment. The electronic device according to this embodiment further includes a voltage monitoring circuit 50 in addition to the components of the electronic device according to the first embodiment. The differences from the first embodiment will be described below.

As shown in FIG. 5 for example, an overshoot or an undershoot occurs in the output voltage Vout of the regulator circuit 10 immediately after a change in the operating mode of the signal processor 20, after which the output voltage Vout stabilizes at a predetermined voltage. The voltage monitoring circuit 50 monitors the output voltage Vout of the regulator circuit 10, detects that the output voltage Vout has stabilized, and notifies the control circuit 30A of the stabilization. Until a notification is received from the voltage monitoring circuit 50, that is, during the time period from when the operating mode of the signal processor 20 is changed until the output voltage Vout of the regulator circuit 10 stabilizes, the control circuit 30A stops changing the operating mode of the signal processor 20. The control circuit 30A and the voltage monitoring circuit 50 may be implemented in a same semiconductor IC.

If a change in the operating mode of the signal processor 20 causes the amount of load to be increased while an undershoot occurs in the output voltage Vout of the regulator circuit 10, then the output voltage Vout may fall below the acceptable range of voltage drop of the signal processor 20. Conversely, if a change in the operating mode of the signal processor 20 causes the amount of load to be reduced while an overshoot occurs, then the output voltage Vout may exceed the acceptable range of voltage increase of the signal processor 20. However, maintaining the operating mode of the signal processor 20 until the output voltage Vout stabilizes allows the amount of change in the output voltage Vout to remain within the acceptable range.

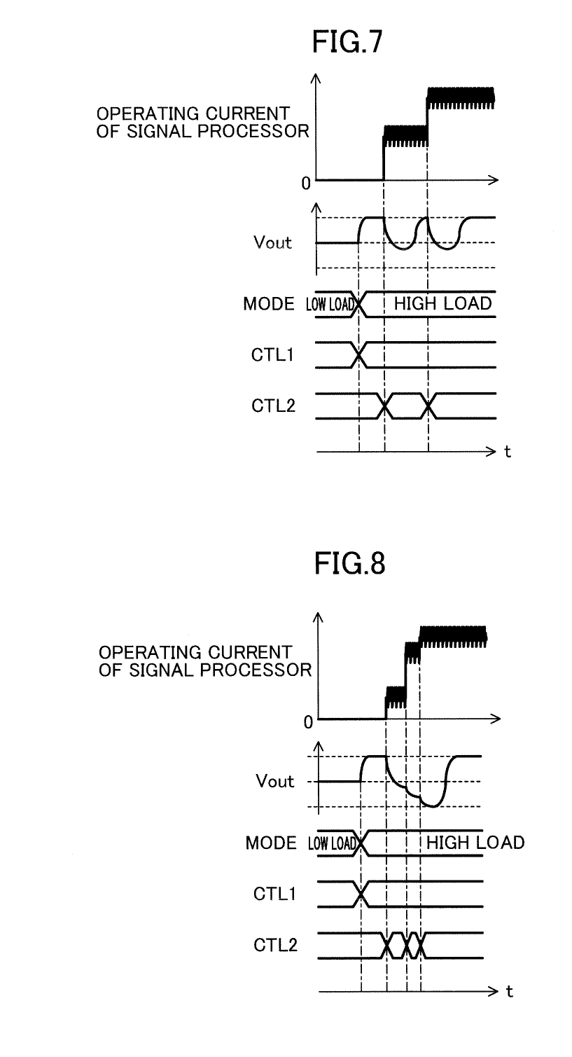

If the operating mode is changed such that the operating current of the signal processor 20 is widely changed—for example, if the operating mode is changed such that the frequency of the clock signal is changed by several gigahertz, then a large undershoot may occur such that even a preliminarily-set higher value of the output voltage Vout of the regulator circuit 10 cannot compensate the undershoot, thereby causing the output voltage Vout to fall below the acceptable range of voltage drop of the signal processor 20. Thus, the change in the operating mode which causes the output voltage Vout to fall below the acceptable range of voltage drop is stored, and if such a change in the operating mode is requested thereafter, the control circuit 30A changes the operating mode of the signal processor 20 in discrete steps. For example, as shown in FIG. 7, the amount of load of the signal processor 20 is not changed directly from low to high in one step, but is first changed to medium, and then, after the output voltage Vout of the regulator circuit 10 is returned to a predetermined voltage, and has stabilized, the amount of load is changed to high. The operating mode may be changed in discrete steps by changing the frequency of the clock signal supplied to the signal processor 20 in discrete steps at a step size of several hundred megahertz, or by changing, in discrete steps, the number of functional cores to operate in the signal processor 20.

If the operating mode of the signal processor 20 is changed in discrete steps, waiting for the output voltage Vout of the regulator circuit 10 to stabilize at a predetermined voltage in each intermediate stage will take a long time before the signal processor 20 starts operating in the requested operating mode. Therefore, as shown in FIG. 8, the operating mode of the signal processor 20 is first changed to an intermediate stage, and then, after a predetermined time period has elapsed since the output voltage Vout fell below the normal voltage, the operating mode is changed to a mode similar to that indicated by the change request. Further after a predetermined time period has elapsed, the operating mode is changed to that indicated by the change request. Such an operation allows the signal processor 20 to start, more quickly, operating in the operating mode indicated by the change request while preventing an extraordinary decrease of the output voltage Vout of the regulator circuit 10 due to a rapid change in the amount of load of the signal processor 20. A situation in which the output voltage Vout has fallen below the normal voltage can be detected, for example, by the voltage monitoring circuit 50.

Thus, according to this embodiment, the operating mode of the signal processor 20 is changed after the output voltage Vout of the regulator circuit 10 has stabilized at a predetermined voltage. Accordingly, the operating mode of the signal processor 20 can be changed more stably. Moreover, by changing the operating mode of the signal processor 20 in discrete steps before the output voltage Vout of the regulator circuit 10 stabilizes, the operating mode of the signal processor 20 can be changed quickly.

Note that the output voltage Vout of the regulator circuit 10 stabilizes in one second at the latest after the operating mode of the signal processor 20 has transitioned to an intermediate state. Therefore, even if the output voltage Vout is not actually monitored, the output voltage Vout of the regulator circuit 10 can be deemed to have stabilized after a predetermined time period, less than or equal to one second, has elapsed since the operating mode of the signal processor 20 transitioned. Thus, the voltage monitoring circuit 50 may be omitted, and in place of this, similarly to the configuration of FIG. 4, the control circuit 30A may include the timer circuit 303 which detects that a predetermined time period has elapsed since the operating mode of the signal processor 20 transitioned to an intermediate stage. In this case, when receiving a timeout notification from the timer circuit 303, the control circuit 30A changes the operating mode of the signal processor 20 to a next stage.

Although the description of this embodiment has described the control signals CTL1 and CTL2 as digital signals, these control signals may be analog signals.

### Third Embodiment

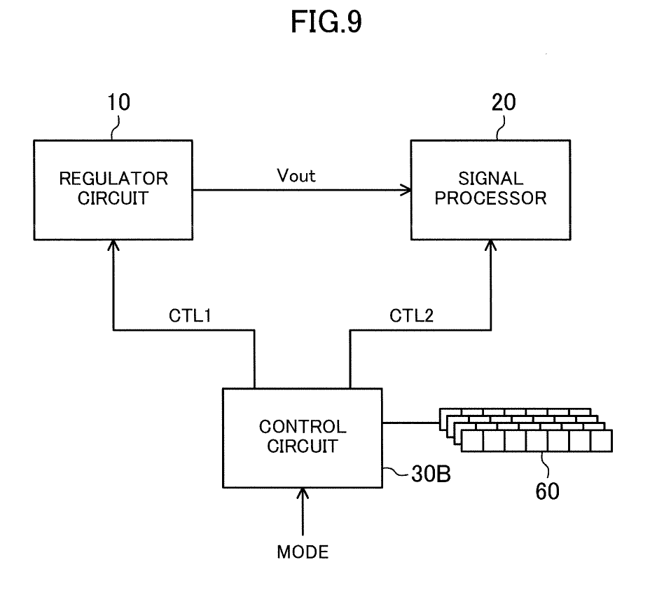

FIG. 9 illustrates a configuration of an electronic device according to the third embodiment. The electronic device according to this embodiment further includes a memory 60 in addition to the components of the electronic device according to the first embodiment. The differences from the first embodiment will be described below.

The memory 60 stores correction information for adjusting, to a predetermined value, a time period from when the output voltage Vout of the regulator circuit 10 is changed until the operating mode of the signal processor 20 is changed. More specifically, the memory 60 can be formed by, for example, an electrically erasable and programmable read only memory (EEPROM). The control circuit 30B adjusts the amount of delay which is provided when the change request MODE is transmitted to the signal processor 20, based on the correction information stored in the memory 60. That is, the control circuit 30B changes the operating mode of the signal processor 20 after the time adjusted based on the correction information stored in the memory 60 has elapsed since the output voltage Vout of the regulator circuit 10 was changed. The control circuit 30B and the memory 60 may be implemented in a same semiconductor IC.

Thus, according to this embodiment, even if semiconductor ICs have manufacturing variation, the time period from when the output voltage Vout of the regulator circuit 10 is changed until the operating mode of the signal processor 20 is changed can be made substantially the same.

Note that the memory 60 may be formed by, for example, a writable non-volatile memory such as a flash memory. In this case, by storing correction information dependent on temperature change etc. in the memory 60, the time period from when the output voltage Vout of the regulator circuit 10 is changed until the operating mode of the signal processor 20 is changed can be made substantially the same even if the operating environment changes.

Although the description of this embodiment has described the control signals CTL1 and CTL2 as digital signals, these control signals may be analog signals.

What is claimed is:

1. A semiconductor integrated circuit (IC) for controlling a regulator circuit and a signal processor which operates based on an output voltage of the regulator circuit, comprising:
a control circuit configured to receive a change request for an operating mode of the signal processor, to change the output voltage of the regulator circuit, and then to change the operating mode of the signal processor based on the change request,
wherein
the control circuit changes a number of functional cores to operate in the signal processor in discrete steps by changing the operating mode of the signal processor in discrete steps.

2. A semiconductor integrated circuit (IC) for controlling a regulator circuit and a signal processor which operates based on an output voltage of the regulator circuit, comprising:
a control circuit configured to receive a change request for an operating mode of the signal processor, to change the output voltage of the regulator circuit, and then to change the operating mode of the signal processor based on the change request,
wherein
the control circuit changes a frequency of a clock signal supplied to the signal processor in discrete steps by changing the operating mode of the signal processor in discrete steps.

3. A semiconductor integrated circuit (IC) for controlling a regulator circuit and a signal processor which operates based on an output voltage of the regulator circuit, comprising:
a control circuit configured to receive a change request for an operating mode of the signal processor, to change the output voltage of the regulator circuit, and then to change the operating mode of the signal processor based on the change request,
wherein
the control circuit changes the operating mode of the signal processor in discrete steps, thereby causing an operating current in the signal processor to change in discrete steps.

4. The semiconductor IC of claim 1, wherein
the operating mode of the signal processor first transitions to an intermediate stage, and then, after the output voltage of the regulator circuit has stabilized, the control circuit changes the operating mode of the signal processor to a next stage.

5. The semiconductor IC of claim 2, wherein
the operating mode of the signal processor first transitions to an intermediate stage, and then, after the output voltage of the regulator circuit has stabilized, the control circuit changes the operating mode of the signal processor to a next stage.

6. The semiconductor IC of claim 3, wherein
the operating mode of the signal processor first transitions to an intermediate stage, and then, after the output voltage of the regulator circuit has stabilized, the control circuit changes the operating mode of the signal processor to a next stage.

7. The semiconductor IC of claim 4, comprising:
a voltage monitoring circuit configured to detect that the output voltage of the regulator circuit has stabilized.

8. The semiconductor IC of claim 5, comprising:
a voltage monitoring circuit configured to detect that the output voltage of the regulator circuit has stabilized.

9. The semiconductor IC of claim 6, comprising:
a voltage monitoring circuit configured to detect that the output voltage of the regulator circuit has stabilized.

10. The semiconductor IC of claim 1, wherein
the control circuit includes a timer circuit configured to detect that a predetermined time period has elapsed since the operating mode of the signal processor transitioned to an intermediate stage, and
when the timer circuit times out, the control circuit changes the operating mode of the signal processor to a next stage.

11. The semiconductor IC of claim 2, wherein
the control circuit includes a timer circuit configured to detect that a predetermined time period has elapsed since the operating mode of the signal processor transitioned to an intermediate stage, and
when the timer circuit times out, the control circuit changes the operating mode of the signal processor to a next stage.

12. The semiconductor IC of claim 3, wherein
the control circuit includes a timer circuit configured to detect that a predetermined time period has elapsed since the operating mode of the signal processor transitioned to an intermediate stage, and
when the timer circuit times out, the control circuit changes the operating mode of the signal processor to a next stage.

13. The semiconductor IC of claim 10, wherein
the predetermined time period is less than or equal to one second.

14. The semiconductor IC of claim 11, wherein
the predetermined time period is less than or equal to one second.

15. The semiconductor IC of claim 12, wherein
the predetermined time period is less than or equal to one second.

16. The semiconductor IC of claim 1, wherein
the operating mode of the signal processor first transitions to an intermediate stage, and then, after a predetermined time period has elapsed since the output voltage of the regulator circuit has become a normal voltage, the control circuit changes the operating mode of the signal processor to a next stage.

17. The semiconductor IC of claim 2, wherein
the operating mode of the signal processor first transitions to an intermediate stage, and then, after a predetermined time period has elapsed since the output voltage of the regulator circuit has become a normal voltage, the control circuit changes the operating mode of the signal processor to a next stage.

18. The semiconductor IC of claim 3, wherein
the operating mode of the signal processor first transitions to an intermediate stage, and then, after a predetermined time period has elapsed since the output voltage of the regulator circuit has become a normal voltage, the control circuit changes the operating mode of the signal processor to a next stage.

19. The semiconductor IC of claim 16, comprising:
a voltage monitoring circuit configured to detect that the output voltage of the regulator circuit has become the normal voltage.

20. The semiconductor IC of claim 17, comprising:
a voltage monitoring circuit configured to detect that the output voltage of the regulator circuit has become the normal voltage.

21. The semiconductor IC of claim 18, comprising:
a voltage monitoring circuit configured to detect that the output voltage of the regulator circuit has become the normal voltage.
